(19) United States
(12) Patent Application Publication
(10) Pub. No.: US 2026/0112133 A1
(43) Pub. Date: Apr. 23, 2026

(54) METHOD AND SYSTEM FOR PROVIDING GUIDANCE FOR MULTIPLE PEOPLE USING IMAGE SUPERPOSITION

(71) Applicant: METAL INDUSTRIES RESEARCH AND DEVELOPMENT CENTRE, Kaohsiung (TW)

(72) Inventors: Wei-Ching WANG, Kaohsiung (TW); Yu-An CHEN, Kaohsiung (TW); Shuo-Yen CHEN, Kaohsiung (TW); Wei-te CHEN, Kaohsiung (TW)

(21) Appl. No.: 19/331,095

(22) Filed: Sep. 17, 2025

(30) Foreign Application Priority Data
Oct. 21, 2024 (TW) 113140001

(51) Int. Cl. G06T 19/00; G06T 17/20

(52) U.S. Cl. CPC G06T 19/006; G06T 17/20

(57) ABSTRACT

A method for providing guidance at an indoor site is implemented using a portable electronic device and a back-end electronic device outside of the indoor site, and includes: obtaining, by the portable electronic device, a reference image of the indoor site, and calculating a set of location coordinates that represents a position of the portable electronic device at the indoor site; transmitting the set of location coordinates to the back-end electronic device; the back-end electronic device generating a virtual object and a set of two-dimensional (2D) displaying coordinates that corresponds to the virtual object, and transmitting the virtual object and the 2D displaying coordinates to the portable electronic device; and displaying, by the portable electronic device, the reference image and the virtual object which is superposed on the reference image on a location of the reference image.

### CROSS-REFERENCE TO RELATED APPLICATION

This application claims priority to Taiwanese Invention Patent Application No. 113140001, filed on Oct. 21, 2024, the entire disclosure of which is incorporated by reference herein.

### FIELD

The disclosure relates to a method and a system for providing guidance, and particularly to a method and a system for providing guidance for multiple people using image superposition.

### BACKGROUND

In the field of renewable energy, wind farms that employ wind turbines are one of the popular choices for generating electricity. As land needed for the construction of onshore wind farms proves to be too costly, offshore wind farms, which are constructed on pelagic zones away from the shore, have become a viable choice for countries that possess marine resources.

Because the wind turbines of the offshore wind farms require regular maintenance and repairs, technicians are required to travel by boats to the offshore wind farms to perform the maintenance and repairs. Since such trips are time-consuming and a number of people that can be fitted in one boat is limited (because the capacity of the boat and the inner space within the wind turbine are limited), experienced technicians are typically preferred for these operations. Nonetheless, inexperienced technicians also need to be guided by the experienced technicians on-site in order to perform the maintenance and repairs in the future.

Additionally, remote teaching may not be desirable because the offshore wind farms are located in the pelagic zones, and the network capacity needed to provide remote teaching is inadequate, especially in the case where multiple people holding multiple electronic devices are to be connected simultaneously.

### SUMMARY

Therefore, one object of the disclosure is to provide a method that can alleviate at least one of the drawbacks of the prior art.

According to one embodiment of the disclosure, a method for providing guidance using image superposition at an indoor site is provided. The method is to be implemented using a system including a portable electronic device held by a user, and a back-end electronic device that is disposed outside the indoor site and that communicates with the portable electronic device. The portable electronic device includes an image capturing unit and a display. The method comprising: the portable electronic device initiating a guiding procedure after the portable electronic device enters the indoor site, and loading a point cloud map of the indoor site; the portable electronic device activating the image capturing unit to obtain a reference image of the indoor site; the portable electronic device calculating a set of location coordinates that represents a position of the portable electronic device at the indoor site based on the reference image and the point cloud map; the portable electronic device transmitting the set of location coordinates to the back-end electronic device; in response to receipt of the set of location coordinates, the back-end electronic device generating at least one virtual object and at least one set of two-dimensional (2D) displaying coordinates that corresponds to the virtual object, and transmitting the virtual object and the 2D displaying coordinates to the portable electronic device; and in response to receipt of the virtual object and the set of 2D displaying coordinates, the portable electronic device displaying the reference image and the virtual object which is superposed on the reference image on a location of the reference image based on the set of 2D displaying coordinates.

Another object of the disclosure is to provide a system for providing guidance using image superposition in an indoor site.

According to one embodiment of the disclosure, the system includes a portable electronic device held by a user, and a back-end electronic device that is disposed outside the indoor site and that communicates with the portable electronic device. The portable electronic device includes an image capturing unit and a display. The portable electronic device and the back-end electronic device are operable to cooperatively implement the method for providing guidance using image superposition at an indoor site.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a flow chart illustrating steps of a method for providing guidance for multiple people using image superposition according to one embodiment of the disclosure.

FIG. 2 illustrates components of a system for providing guidance for multiple people using image superposition according to one embodiment of the disclosure.

FIG. 3 illustrates an exemplary recreated image according to one embodiment of the disclosure.

FIG. 4 illustrates an exemplary indoor site with a top viewing shape of a rectangle.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

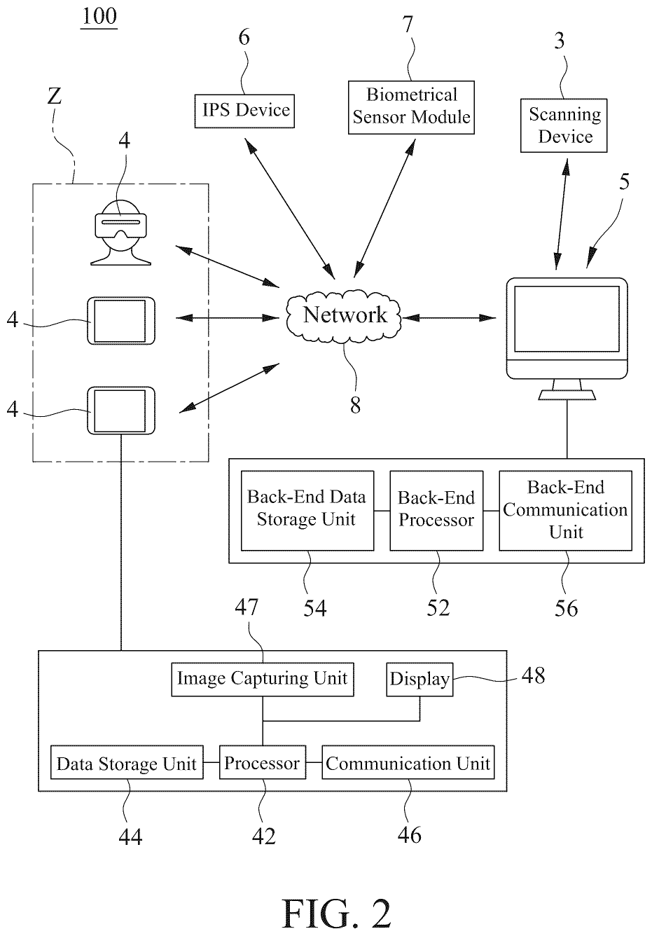

FIG. 2 illustrates components of a system 100 for providing guidance for multiple people using image superposition according to one embodiment of the disclosure. In this embodiment, the system 100 includes a scanning device 3, at least one portable electronic device 4, a back-end electronic device 5, a plurality of indoor positioning system (IPS) devices 6, and a biometrical sensor module 7.

In some embodiments, the system 100 is to be used at an indoor site (Z). In some embodiments, the indoor site (Z) may be a control room of a wind turbine located at an offshore wind farm or other suitable indoor sites in other embodiments. Typically, the indoor site (Z) is installed with equipment that may need regular maintenance and repair. The scanning device 3 may be embodied using a handheld three-dimensional (3D) scanner or other suitable devices that is capable of scanning the indoor site (Z) to obtain a 3D model inside the indoor site (Z) that includes data constituting a point cloud. Using the 3D model, a point cloud map of the indoor site Z, including the equipment therein, may be constructed.

The portable electronic device 4 may be embodied using a dedicated portable device that includes a display screen and that has network connectivity, or a pair of smart glasses that has network connectivity and that is capable of receiving and displaying images thereon. Generally, the portable electronic device 4 is held or worn by a user, and includes a processor 42, a data storage unit 44, a communication unit 46, an image capturing unit 47 and a display 48. It is noted that while in the embodiment of FIG. 2, three portable electronic devices 4 are present (two being dedicated portable devices and one being smart glasses), in other embodiments, different numbers of portable electronic devices 4 may be present.

The processor 42 may be embodied using a central processing unit (CPU), a microprocessor, a microcontroller, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The data storage unit 44 is connected to the processor 42, and may be embodied using, for example, random access memory (RAM), read only memory (ROM), programmable ROM (PROM), firmware, flash memory or other suitable non-transitory storage media. In this embodiment, the data storage unit 44 stores a software application therein. The software application includes instructions that, when executed by the processor 42, cause the processor 42 to implement the operations as described below.

The communication unit 46 is connected to the processor 42, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G) of, the fourth generation (4G) of or the fifth generation (5G) of wireless mobile telecommunications technology, or the like.

The image capturing unit 47 may be embodied using a camera module. The display 48 may be embodied using a standalone display screen or a touchscreen, and may be controlled by the processor 42 to display content. In the case where the portable electronic devices 4 is a pair of smart glasses, the image capturing unit 47 and the display 48 may be built-in components.

The back-end electronic device 5 may be embodied using a server, a personal computer, a laptop, or other suitable electronic devices. In practice, the back-end electronic device 5 includes a back-end processor 52, a back-end data storage unit 54 and a back-end communication unit 56. Generally, the back-end electronic device 5 is not disposed at the indoor site (Z), and communicates with the portable electronic devices 4 via wireless communication.

The back-end processor 52 may be embodied using components that are similar to those of the processor 42. The back-end data storage unit 54 may be embodied using components that are similar to those of the data storage unit 44. The back-end communication unit 56 may be embodied using components that are similar to those of the communication unit 46. In practice, the back-end electronic device 5 may communicate with the portable electronic devices 4 via a network 8 (e.g., the Internet).

The IPS devices 6 may be embodied using, for example, IPS beacons that support ultra wideband (UWB) or other suitable positioning technologies, and are disposed at the indoor site (Z) to form an IPS system. In different embodiments, based on the size and/or a top viewing shape of the indoor site (Z), a number of IPS devices 6 to be disposed and an arrangement of the IPS devices 6 may differ from other another.

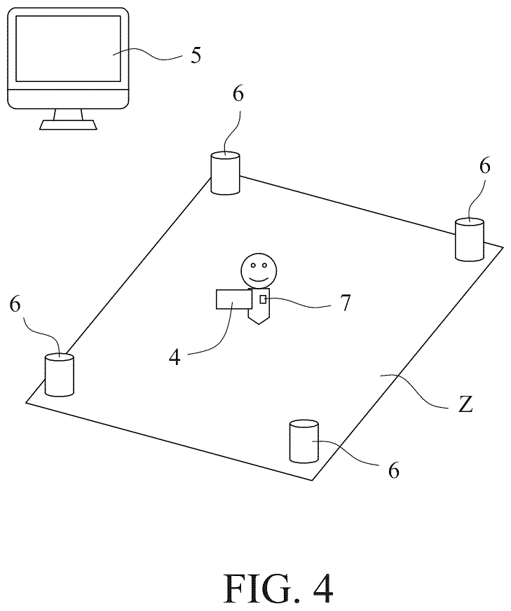

In some cases where the top viewing shape of the indoor site (Z) forms a polygon with a plurality of corners, the IPS devices 6 are placed at corners of the indoor site (Z). FIG. 4 illustrates an exemplary indoor site (Z) with a top viewing shape of a rectangle. In the embodiment of FIG. 4, four IPS devices 6 are disposed at the four corners of the indoor site (Z). In other cases, the IPS devices 6 may be arranged to cover as much of the area of the indoor site (Z). Generally, the initial ranges of the IPS devices 6 cooperatively form a detecting range within the indoor site (Z), and are able to detect an accurate location of the portable electronic device 4 within the detecting range. In some embodiments, the IPS devices 6 are placed such that the detecting range covers over 90 percent of the indoor site (Z).

Each of the IPS devices 6 is capable of detecting a specific object within an initial range (e.g., a circular area with the IPS device 6 as a center) of the portable electronic device 4. That is to say, when the portable electronic device 4 is moved within the initial area of one of the IPS devices 6, the one of the IPS devices 6 may be capable of detecting an accurate location of the portable electronic device 4 in the form of a set of coordinates.

The biometrical sensor module 7 is mounted on a user at the indoor site (Z), and may include sensors for detecting biometrical data of the user such as heart rate, blood pressure, etc. In some embodiments, the biometrical sensor module 7 may further include a gyroscope for detecting orientation data related to orientation of the user. Using the orientation data of the user detected by the biometrical sensor module 7, it may be determined whether the user is not in a normal standing position (e.g., falling down, being upside down, etc.).

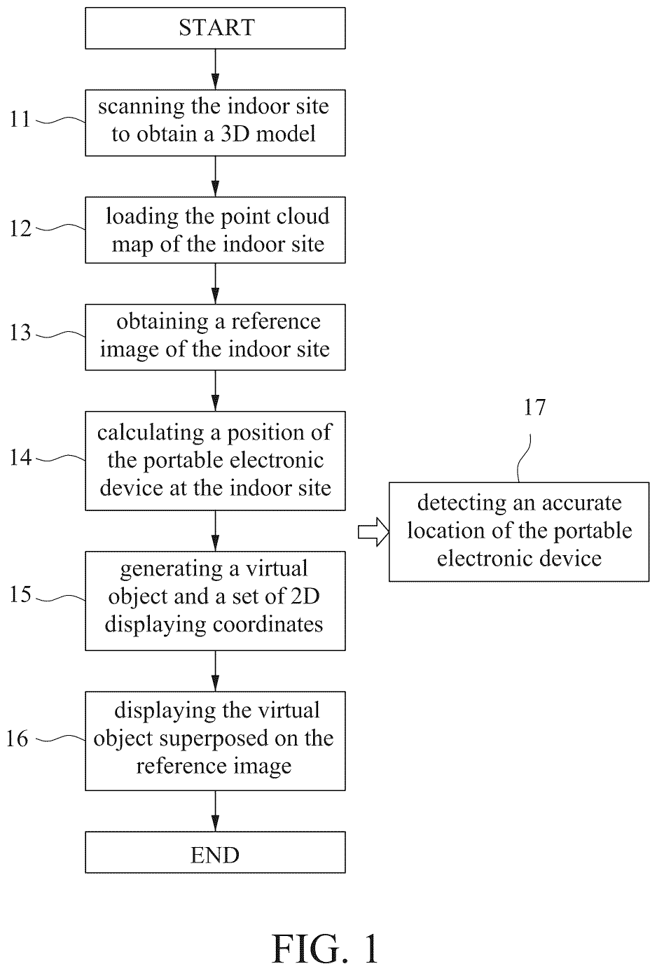

FIG. 1 is a flow chart illustrating steps of a method for providing guidance for multiple people using image superposition according to one embodiment of the disclosure. In the embodiment of FIG. 1, the method is implemented using the system of FIG. 2. It is noted that for simplifying of the description, the method is described with respect to only one portable electronic device 4 held by one user, but may be implemented with respect to multiple users each holding one portable electronic

### Device 4 in Other Embodiments.

In step 11, the scanning device 3 is operated to scan the indoor site (Z) to obtain a 3D model of the indoor site (Z) that includes point cloud data, so as to construct a point cloud map of the indoor site (Z). In some embodiments, the scanning device 3 may be held by a technician who walks through the indoor site (Z) to implement the scanning. Then, the point cloud map may be transmitted to the back-end electronic device 5 for storage.

Afterward, when a user holding a portable electronic device 4 enters the indoor site (Z), he/she may operate the portable electronic device 4 to initiate a guiding procedure. In response, in step 12, the portable electronic device 4 initiates a wireless communication with the back-end electronic device 5 and loads the point cloud map of the indoor site (Z) from the back-end electronic device 5. It is noted that in embodiments, the portable electronic device 4 may be operated to download the point cloud map of the indoor site (Z) from the back-end electronic device 5 and store the same prior to the user entering the indoor size (Z), and to load the point cloud map after initiating the guiding procedure.

Then, in step 13, the processor 42 of the portable electronic device 4 activates the image capturing unit 47, so as to obtain a reference image of the indoor site (Z).

Then, in step 14, the processor 42 calculates, based on the reference image and the point cloud map, a position of the portable electronic device 4 at the indoor site (Z). Specifically, since the point cloud map is stored in the portable electronic device 4, the processor 42 is capable of using the point cloud map and the reference image of the indoor site (Z) to calculate a set of location coordinates representing the position of the portable electronic device 4 at the indoor site (Z) using suitable techniques known in the related art, such as feature image analysis computation. Specifically, the set of location coordinates are coordinates in a three-dimensional (3D) coordinate system associated with the indoor site (Z) defined by the point cloud map.

Then, the processor 42 of the portable electronic device 4 controls the communication unit 46 to transmit the set of location coordinates to the back-end electronic device 5. In some embodiments, the processor 42 further calculates an orientation of the portable electronic device 4 based on the reference image and the point cloud map, and transmits the orientation of the portable electronic device 4 to the back-end electronic device 5.

In response to receipt of the set of location coordinates, in step 15, the back-end electronic device 5 generates at least one virtual object and at least one set of two-dimensional (2D) displaying coordinates that corresponds to the virtual object, and transmits the virtual object and the 2D displaying coordinates to the portable electronic device 4.

It is noted that in some embodiments, the back-end electronic device 5 may generate a recreated image based on the set of location coordinates and the point clout map, and to display the recreated image. The recreated image is generated for showing the content of the reference image on the back-end electronic device 5 without the portable electronic device 4 actually transmitting the reference image to the back-end electronic device 5. Then, an experienced technician may operate the back-end electronic device 5 to provide marks on the reference image. The marks may be in the form of, for example, handwritings, drawings, markings, etc.

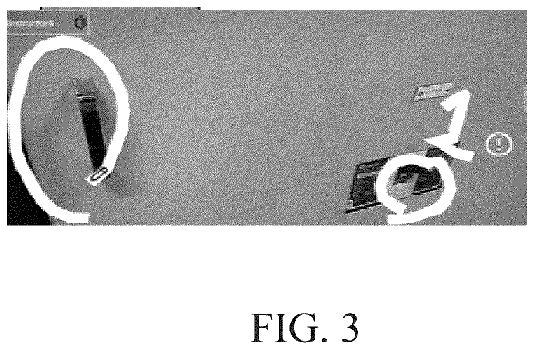

FIG. 3 illustrates an exemplary recreated image according to one embodiment of the disclosure. In the embodiment of FIG. 3, the experienced technician uses a brush function to draw circles and numerals with respect to the specific components included in the recreated image (i.e., a panel, a handle, etc.). The back-end electronic device 5 then stores the circles and numerals as the virtual objects, and records locations of the circles and numerals in the form of the 2D displaying coordinates. It is noted that the 2D displaying coordinates reflects a location on the reference image, and may be transformed based on a set of 2D coordinates of the virtual object on the recreated image and a spatial relationship between the reference image and the recreated image. In this manner, the experienced technician may be able to provide guidance on the operation of the equipment at the indoor site, and/or provide a step-by-step demonstration on maintenance and repairs of the equipment at the indoor site Z.

It is noted that in some embodiments, a number of virtual objects may be pre-generated and associated with the different components of the equipment. In the case where one of the components is included in the recreated image, a corresponding one of the virtual objects may be selected, and the corresponding set of 2D displaying coordinates may be calculated based on a location of the one of the components in the recreated image.

Then, in response to receipt of the virtual object and the set of 2D displaying coordinates, in step S16, the processor 42 of the portable electronic device 4 controls the display 48 to display the reference image and the virtual object which is superposed on the reference image. Specifically, the virtual object is superposed on a location of the reference image based on the set of 2D displaying coordinate. As such, the guidance provided by the back-end electronic device 5 is shown on the portable electronic device 4 for the user.

In some embodiments, the method further includes step 17, in which the IPS devices 6 are activated to detect an accurate location of the portable electronic device 4 in the form of a set of accurate coordinates, and to transmit the set of accurate coordinates of the portable electronic device 4 to the back-end electronic device 5. In this manner, the set of accurate coordinates may be generated with respect to another 3D coordinate system defined by the IPS devices 6, and be used to verify the accuracy of the set of location coordinates.

In some cases where the user further wears the biometrical sensor module 7, the IPS devices 6 may further establish a communication with the biometrical sensor module 7 via wireless communication (e.g., near field communication (NFC), Bluetooth®, etc.) to receive the biometrical data of the user and/or the orientation data of the user, and to transmit the biometrical data of the user and/or the orientation data of the user to the back-end electronic device 5. As such, the safety of the user in the indoor site Z may be monitored remotely as long as the user remains in the detecting range. In the cases where the biometrical sensor module 7 supports network communication, the biometrical sensor module 7 may directly transmit the biometrical data of the user to the back-end electronic device 5.

In sum, embodiments of the disclosure provide a method and a system for providing guidance for multiple people using image superposition. In the method, a point cloud map of an indoor site is first established. After a portable electronic device is moved into the indoor site, an image capturing unit is activated to obtain a reference image, and using the reference image and the point cloud map, a location of the portable electronic device inside the indoor site is calculated in the form of a set of location coordinates, and transmitted to a back-end electronic device. In response to receipt of the set of location coordinates, the back-end electronic device generates at least one virtual object and at least one set of two-dimensional (2D) displaying coordinates that corresponds to the virtual object, and transmits the virtual object and the 2D displaying coordinates to the portable electronic device. Then, the portable electronic device displays the reference image and the virtual object which is superposed on the reference image, therefore providing the user with the guidance needed for operating the equipment at the indoor site.

One effect of the method is that, the data transmitted between the portable electronic device and the back-end electronic device is mainly in the form of sets of coordinates instead of images captured by the portable electronic device. As such, the requirement for network capability (i.e., a required data transmission rate) is greatly reduced since the amount of data need to be transmitted is also reduced compared to transmitting images. This configuration may be particularly beneficial in the cases where the indoor site is located remotely such as in pelagic zones. The method is also applicable in the cases where multiple users each holding one portable electronic device are at the indoor site because the amount of data that needs to be transmitted from multiple portable electronic device is still low using the method. As such, using the method, a plurality of users may simultaneously be at the indoor site to receive guidance.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for providing guidance using image superposition at an indoor site, implemented using a system that includes a portable electronic device held by a user and a back-end electronic device that is disposed outside the indoor site and that communicates with the portable electronic device, the portable electronic device including an image capturing unit and a display, the method comprising:
the portable electronic device initiating a guiding procedure after the portable electronic device enters the indoor site, and loading a point cloud map of the indoor site;
the portable electronic device activating the image capturing unit to obtain a reference image of the indoor site;
the portable electronic device calculating a set of location coordinates that represents a position of the portable electronic device at the indoor site based on the reference image and the point cloud map;
the portable electronic device transmitting the set of location coordinates to the back-end electronic device;
in response to receipt of the set of location coordinates, the back-end electronic device generating at least one virtual object and at least one set of two-dimensional (2D) displaying coordinates that corresponds to the virtual object, and transmitting the virtual object and the 2D displaying coordinates to the portable electronic device; and
in response to receipt of the virtual object and the set of 2D displaying coordinates, the portable electronic device displaying the reference image and the virtual object which is superposed on the reference image on a location of the reference image based on the set of 2D displaying coordinates.

2. The method as claimed in claim 1, the system further including a scanning device, the method further comprising, prior to initiating the guiding procedure:
the scanning device scanning the indoor site to obtain a 3D model of the indoor site that includes point cloud data, so as to construct a point cloud map of the indoor site;
the scanning device transmitting the point cloud map of the indoor site to the back-end electronic device for storage; and
the portable electronic device downloading the point cloud map of the indoor site from the back-end electronic device.

3. The method as claimed in claim 1, the system further including an indoor positioning system (IPS) device disposed at the indoor site, the method further comprising:
the IPS device detecting an accurate location of the portable electronic device in a form of a set of accurate coordinates, and transmitting the set of accurate coordinates of the portable electronic device to the back-end electronic device.

4. The method as claimed in claim 3, the system further including a biometrical sensor module disposed on the user to detect biometrical data of the user, the method further comprising:
the IPS device establishing communication with the biometrical sensor module to receive the biometrical data of the user and the orientation data of the user, and to transmit the biometrical data of the user and the orientation data of the user to the back-end electronic device.

5. The method as claimed in claim 4, the system including a plurality of IPS devices, each of the plurality of IPS devices being capable of detecting objects within an initial range, wherein the IPS devices are disposed in a plurality of corners of the indoor site, respectively, such that the initial ranges of the IPS devices cooperatively form a detecting range within the indoor site.

6. The method as claimed in claim 3, the system including a plurality of IPS devices, each of the plurality of IPS devices being capable of detecting objects within an initial range, wherein disposing the IPS devices are disposed in a plurality of corners of the indoor site, respectively, such that the initial ranges of the IPS devices cooperatively form a detecting range within the indoor site.

7. A system for providing guidance using image superposition in an indoor site, comprising:
a portable electronic device held by a user, the portable electronic device including an image capturing unit and a display; and
a back-end electronic device that is disposed outside the indoor site and that communicates with the portable electronic device,
wherein the portable electronic device and the back-end electronic device are operable to cooperatively implement the method of claim 1.

8. The system as claimed in claim 7, further comprising a scanning device that is operable to, prior to initiating the guiding procedure:
scan the indoor site to obtain a 3D model of the indoor site that includes point cloud data, so as to construct a point cloud map of the indoor site; and
transmit the point cloud map of the indoor site to the back-end electronic device for storage;
wherein the portable electronic device is operable to download the point cloud map of the indoor site from the back-end electronic device prior to initiating the guiding procedure.

9. The system as claimed in claim 7, further comprising an indoor positioning system (IPS) device disposed at the indoor site,
wherein the IPS device detects an accurate location of the portable electronic device in a form of a set of accurate coordinates, and transmits the set of accurate coordinates of the portable electronic device to the back-end electronic device.

10. The system as claimed in claim 9, further comprising a biometrical sensor module disposed on the user to detect biometrical data of the user,
wherein the IPS device establishes communication with the biometrical sensor module to receive the biometrical data of the user and the orientation data of the user, and to transmit the biometrical data of the user and the orientation data of the user to the back-end electronic device.

11. The system as claimed in claim 10, comprising a plurality of IPS devices,
wherein each of the plurality of IPS devices is capable of detecting objects within an initial range, and the plurality of IPS devices are disposed in a plurality of corners of the indoor site, respectively, such that the initial ranges of the IPS devices cooperatively form a detecting range within the indoor site.

12. The system as claimed in claim 9, comprising a plurality of IPS devices,
wherein each of the plurality of IPS devices being capable of detecting objects within an initial range, and the plurality of IPS devices are disposed in a plurality of corners of the indoor site, respectively, such that the initial ranges of the IPS devices cooperatively form a detecting range within the indoor site.
